(19) United States
(12) Patent Application Publication
(10) Pub. No.: US 2023/0162712 A1
(43) Pub. Date: May 25, 2023

(54) MUSICAL PIECE INFERENCE DEVICE, MUSICAL PIECE INFERENCE METHOD, MUSICAL PIECE INFERENCE PROGRAM, MODEL GENERATION DEVICE, MODEL GENERATION METHOD, AND MODEL GENERATION PROGRAM

(71) Applicant: Yamaha Corporation, Hamamatsu (JP)

(72) Inventor: Masahiro SUZUKI, Hamamatsu (JP)

(21) Appl. No.: 17/991,823

(22) Filed: Nov. 21, 2022

(30) Foreign Application Priority Data
Nov. 24, 2021 (JP) 2021-190294

(51) Int. Cl. G10H 1/00; G06N 5/04

(52) U.S. Cl. CPC G10H 1/0025; G06N 5/04; G10H 2210/111; G10H 2210/061; G10H 2210/076

(57) ABSTRACT

A musical piece inference device includes an electronic controller configured to execute a data acquisition module, an inference module, and an output module. The data acquisition module is configured to acquire target data including an input token sequence that is arranged to indicate at least a part of a musical piece and includes a plurality of bar-line/beat tokens arranged to indicate bar-line/beat positions of at least the part of the musical piece. The bar-line/beat positions are positions of bar lines of at least the part of the musical piece, positions of beats of at least the part of the musical piece, or both. The inference module is configured to, by using a trained inference model, generate an output token sequence indicating a result of an inference with respect to the musical piece from the input token sequence. The output module is configured to output the result of the inference.

### CROSS-REFERENCE TO RELATED APPLICATIONS

This application claims priority to Japanese Patent Application No. 2021-190294, filed on Nov. 24, 2021. The entire disclosure of Japanese Patent Application No. 2021-190294 is hereby incorporated herein by reference.

### BACKGROUND

### Technical Field

This disclosure relates to a musical piece inference device, a musical piece inference method, a musical piece inference program, a model generation device, a model generation method, and a model generation program.

### Background Information

Conventionally, drawing inferences with respect to a musical piece, such as generating an arranged musical piece, generating a musical score of the musical piece, and estimating attributes of the musical piece, has primarily been performed manually by people. However, if all of the inference work with respect to musical pieces is performed manually, the costs associated therewith will be high. Thus, methods for using computer technology to automate at least a part of the inference work with respect to musical pieces are being developed.

For example, Japanese Laid-Open Patent Application No. 2017-58594 proposes a technology for automatically generating accompaniment (backing) data by arrangement. Further, in recent years, AI (artificial intelligence) technology has come to be used as a method for automating the inference work with respect to musical pieces. For example, Cheng-Zhi Anna Huang, Ashish Vaswani, Jakob Uszkoreit, Noam Shazeer, Ian Simon, Curtis Hawthorne, Andrew M. Dai, Matthew D. Hoffman, Monica Dinculescu, Douglas Eck, “Music Transformer”. [online], [searched on Sep. 24, 2021], the Internet <URL: https://arxiv.org/abs/1809.04281> proposes a method for using a model trained by machine learning to automatically generate a musical piece. Such technologies can reduce the cost of inference work for musical pieces.

### SUMMARY

The present inventor has found that the following problems are associated with the conventional methods of musical piece inference using AI technology. That is, in general, in methods using conventional AI technology, information indicating a musical piece, such as notes, is tokenized, and the obtained token sequence is input to a trained model to execute a arithmetic processing of the trained model (for example, Sageev Oore, Ian Simon, Sander Dieleman, Douglas Eck, Karen Simonyan, “This Time with Feeling: Learning Expressive Musical Performance” [online], [searched Sep. 24, 2021], the Internet <URL: https://arxiv.org/abs/1808.03715>, and Yu-Siang Huang, Yi-Hsuan Yang, “Pop Music Transformer: Beatbased Modeling and Generation of Expressive Pop Piano Compositions”, [online], [searched on Sep. 24, 2021], the Internet <URL: https://arxiv.org/abs/2002.00212>). By this arithmetic processing, the output of the token sequence indicating the inference result is acquired from the trained model. At this time, there are cases in which a temporal error can occur in the obtained inference result. As an example, a case is assumed in which a trained model is used to automatically generate an accompaniment from a musical piece. In such cases, an error can occur in which the playing time of the generated accompaniment does not match the playing time of the original musical piece. Since it is difficult to identify the cause and location of such an error, if one were to occur, there is the problem that it will be difficult to correct the obtained inference result (as an example, in the above-described case, correcting the time length of the obtained accompaniment data). Scenarios in which temporal errors occur are not limited to such cases of automatically generating accompaniments; similar problems can arise in any scenario in which an inference process is performed with respect to a musical piece by a trained model.

This disclosure was conceived in light of the foregoing circumstances, and an object thereof is to provide a technology for reducing the probability that a temporal error will occur in drawing an inference with respect to a musical piece.

In order to solve the above-mentioned problem, this disclosure adopts the following configuration.

According to one aspect of this disclosure, a musical piece inference device comprises an electronic controller including at least one processor. The electronic controller is configured to execute a plurality of modules including a data acquisition module, an inference module, and an output module. The data acquisition module is configured to acquire target data including an input token sequence arranged to indicate at least a part of a musical piece, and the input token sequence includes a plurality of bar-line/beat tokens arranged to indicate bar-line/beat positions of at least the part of the musical piece. The bar-line/beat positions are positions of bar lines of at least the part of the musical piece, positions of beats of at least the part of the musical piece, or both. The inference module is configured to, by using a trained inference model, generate an output token sequence indicating a result of an inference with respect to the musical piece from the input token sequence included in the target data. The output module is configured to output the result of the inference.

According to another aspect of this disclosure, a musical piece inference method that is executed by a computer comprises acquiring target data including an input token sequence that is arranged to indicate at least a part of a musical piece and includes a plurality of bar-line/beat tokens arranged to indicate bar-line/beat positions of at least the part of the musical piece, generating an output token sequence by using a trained inference model, the output token sequence indicating a result of an inference with respect to the musical piece from the input token sequence included in the target data, and outputting the result of the inference. The bar-line/beat positions are positions of bar lines of at least the part of the musical piece, positions of beats of at least the part of the musical piece, or both.

According to another aspect of this disclosure, a model generation device comprises an electronic controller including at least one processor. The electronic controller is configured to execute a plurality of modules including a training data acquisition module and a training processing module. The training data acquisition module is configured to acquire a plurality of training datasets each of which includes a combination of training data and a correct answer label, the training data include an input token sequence arranged to indicate at least a part of a musical piece for training, and the input token sequence includes a plurality of bar-line/beat tokens arranged to indicate bar-line/beat positions of at least the part of the musical piece. The bar-line/beat positions are positions of bar lines of at least the part of the musical piece, positions of beats of at least the part of the musical piece, or both. The correct answer label is configured to indicate a true value of an output token sequence corresponding to a result of an inference with respect to the musical piece. The training processing module is configured to execute machine learning of an inference model by using the plurality of training datasets. The machine learning is configured by training the inference model such that, with respect to each of the training datasets, an output token sequence generated by the inference model from the input token sequence included in the training data matches the true value indicated by the correct answer label.

### BRIEF DESCRIPTION OF THE DRAWINGS

FIG. 1 schematically illustrates an example of a scenario in which this disclosure has been applied.

FIG. 2 schematically illustrates an example of a hardware configuration of a model generation device according to an embodiment.

FIG. 3 schematically illustrates an example of the hardware configuration of a musical piece inference device according to the embodiment.

FIG. 4 schematically illustrates an example of the hardware configuration of the model generation device according to the embodiment.

FIG. 5 is a musical score showing an example of a musical piece.

FIG. 6A shows an example of an input token sequence generated from the musical piece of FIG. 5.

FIG. 6B shows an example of the input token sequence generated from the musical piece of FIG. 5.

FIG. 7 is a musical score showing an example of an arranged musical piece (inference result).

FIG. 8A shows an example of a true value of an output token sequence corresponding to the musical piece of FIG. 7.

FIG. 8B shows an example of a true value of the output token sequence corresponding to the musical piece of FIG. 7.

FIG. 9 schematically illustrates an example of the configuration of an inference model according to the embodiment.

FIG. 10 schematically illustrates an example of a software configuration of the musical piece inference device according to the embodiment.

FIG. 11 is a flowchart showing an example of a processing procedure of the model generation device according to the embodiment.

FIG. 12 is a flowchart showing an example of a processing procedure of the musical piece inference device according to the embodiment.

### DETAILED DESCRIPTION OF THE EMBODIMENTS

An embodiment according to one aspect of this disclosure (hereinafter also referred to as the “present embodiment”) will be described below with reference to the drawings. However, the present embodiment described below is merely an example of this disclosure in all respects. Various improvements and modifications can of course be made without departing from the scope of this disclosure. That is, when this disclosure is implemented, specific configurations that correspond to the embodiment can be appropriately employed. Although the data that appear in the present embodiment are described using natural language, the data can be specified more specifically in pseudo language, commands, parameters, machine language, etc., that can be recognized by a computer.

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### § 1 Application Example

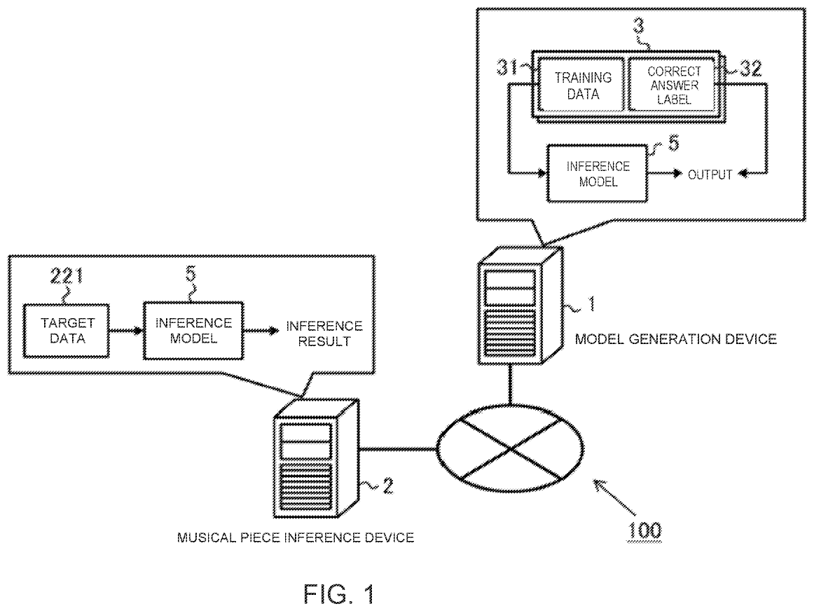

FIG. 1 schematically illustrates an example of a scenario in which this disclosure is applied. As shown in FIG. 1, an inference system 100 according to the present embodiment comprises a model generation device 1 and a musical piece inference device 2.

The model generation device 1 according to the present embodiment is a computer configured to generate by machine learning, a trained inference model 5 for executing an inference task with respect to a musical piece. First, the model generation device 1 acquires a plurality of training datasets 3. Each of the training datasets 3 includes a combination of training data 31 and a correct answer label 32. The training data 31 are configured to include an input token sequence arranged to indicate at least a part of a musical piece for training. The input token sequence includes a plurality of bar-line/beat tokens arranged to indicate the bar-line/beat positions of at least the part of the musical piece. The correct answer label 32 is configured to indicate the true value of an output token sequence corresponding to an inference result (a result of an inference) with respect to the musical piece.

The model generation device 1 then uses the acquired plurality of training datasets 3 to execute the machine learning of the inference model 5. The machine learning is configured by training the inference model 5 such that, with respect to each of the training datasets 3, an output token sequence generated by the inference model 5 from the input token sequence included in the training data 31 matches the true value indicated by the corresponding correct answer label 32. This machine learning process can produce a trained inference model 5 that has acquired the ability to execute an inference task with respect to the musical piece.

On the other hand, the musical piece inference device 2 according to the present embodiment is a computer configured to use the trained inference model 5 to execute an inference task with respect to a musical piece. First, the musical piece inference device 2 acquires target data 221 including an input token sequence arranged to indicate at least a part of the musical piece. The input token sequence includes a plurality of bar-line/beat tokens arranged to indicate the bar-line/beat positions of at least the part of the musical piece. The musical piece inference device 2 then uses the trained inference model 5 to generate inference result data including an output token sequence indicating the result of inference with respect to a musical piece from the input token sequence included in the target data 221. The musical piece inference device 2 outputs the acquired inference result.

The input token sequence of the target data 221 and the training data 31 can be suitably acquired in accordance with the implementation. As an example, the musical piece can be acquired as performance information of other representations, such as encoded data (MIDI, etc.) or a musical score. The input token sequences of the target data 221 and the training data 31 can be generated from performance information acquired by a conversion process, such as natural language processing. The conversion process can be executed by a computer other than the devices (1, 2). Further, the conversion process can be executed at any timing. Each of the devices (1, 2) can acquire the input token sequence directly, or acquire performance information of another representation, and generate an input token sequence from the acquired performance information.

The inference task to be executed by the inference model 5 can include drawing any inference with respect to at least a part of the musical piece. The input token sequence and the output token sequence can be suitably configured in accordance with the inference task.

As an example, the inference task can be to generate a sequence of notes of an arranged musical piece from a sequence of notes of a musical piece. A sequence of notes is the sequence of notes that constitute a musical piece. An arrangement can be, for example, a change in the degree of difficulty of the musical piece, a reduction (conversion from a multi-instrument note sequence to a solo-instrument note sequence), etc. In this case, the input token sequence included in each of the target data 221 and the training data 31 can be configured to correspond to the sequence of notes of at least a part of the musical piece. The output token sequence in the inference result data can be generated so as to indicate the sequence of notes of at least a part of an arranged musical piece, as a result of drawing an inference with respect to a musical piece. The output token sequence of the correct answer label 32 can be configured to indicate the true values of the sequence of notes of at least a part of the arranged musical piece, corresponding to the associated training data 31, as the true values of the inference result.

As another example, the inference task can be to estimate local attributes of a musical piece from the sequence of notes of the musical piece. Local attributes can be, for example, the chords, tones, time signatures, and the timings at which these change. In this case, the input token sequence included in each of the target data 221 and the training data 31 can be configured to correspond to the sequence of notes of at least a part of the musical piece. The output token sequence in the inference result data can be generated so as to indicate the local attributes of at least a part of a musical piece, as a result of an inference with respect to the musical piece. The output token sequence of the correct answer label 32 can be configured to indicate the true values of estimating the local attributes of at least a part of the musical piece, corresponding to the associated training data 31, as the true values of the inference result.

As another example, the inference task can be generating a musical score from a sequence of notes of the musical piece. In this case, the input token sequence included in each of the target data 221 and the training data 31 can be configured to correspond to the sequence of notes of at least a part of the musical piece. The output token sequence in the inference result data can be generated so as to indicate a musical score of at least a part of a musical piece, as a result of an inference with respect to a musical piece. The output token sequence of the correct answer label 32 can be configured to indicate the true values of the musical score of at least a part of the musical piece, corresponding to the associated training data 31, as the true values of the inference result.

As another example, the inference task can be to generate a sequence of notes of an arranged musical piece from a sequence of elements of a musical piece. The sequence of elements is the sequence of elements (material) that constitute a musical piece. The elements are, for example, the melody (melody), chords (harmony), rhythm, etc. In this case, the input token sequence included in each of the target data 221 and the training data 31 can be configured to correspond to the sequence of elements of at least a part of the musical piece. The output token sequence in the inference result data can be generated to indicate the sequence of notes of at least a part of an arranged musical piece, as a result of an inference with respect to a musical piece. The output token sequence of the correct answer label 32 can be configured to indicate the true values of the sequence of notes of at least a part of the arranged musical piece, corresponding to the associated training data 31, as the true values of the inference result.

As another example, the inference task can be to generate a sequence of notes from a sequence of elements of the musical piece indicating a motif. The generated sequence of notes can be configured to indicate a melody or an arranged musical piece. In this case, the input token sequence included in each of the target data 221 and the training data 31 can be configured to correspond to the sequence of elements of at least a part of the musical piece. The output token sequence in the inference result data can be generated so as to indicate the sequence of notes of at least a part of a musical piece, as a result of an inference with respect to the musical piece. The output token sequence of the correct answer label 32 can be configured to indicate the true values of the sequence of notes of at least a part of the musical piece, corresponding to the associated training data 31, as the true values of the inference result.

Each of the plurality of bar-line/beat tokens (indicator tokens) is appropriately arranged to indicate the bar-line/beat structure of the musical piece in the input token sequence. Specifically, the bar-line/beat tokens are arranged in the input token sequence to indicate the positions of the bar lines of the musical piece and/or the positions of the beats of the musical piece. The bar line indicates a break between bars. Bars are divisions of appropriate lengths that make the musical score easier to read. A beat is a unit that divides the temporal continuity of music. In one example, each bar-line/beat token can be arranged to indicate either a bar line or a beat. As a result, it is possible to ascertain the bar-line/beat structure of the musical piece using the bar-line/beat tokens as a cue. However, the bar-line/beat structure varies from one musical piece to another. There are musical pieces in which the time signature changes in the middle of the musical piece. It is difficult to completely ascertain the bar-line/beat structure of various types of musical pieces using only either bar lines or beats. Thus, the bar-line/beat tokens are preferably arranged at each bar line and beat in the input token sequence of each of the training data 31 and the target data 221.

The tokens in the input token sequence and the output token sequence can be suitably constituted by symbols such as numbers, characters, and graphics. Similarly, each bar-line/beat token can be suitably constituted by symbols such as numbers, characters, and graphics. The symbols and data formats used for the tokens are not particularly limited as long as the symbols and data can be recognized by a computer, and can be suitably selected in accordance with the implementation. FIGS. 6A, 6B, 8A, and 8B, described further below, show examples of each token.

In the conventional method, information indicating the bar-line/beat structure of the musical piece is not included in the token sequence that is input to the trained model. As a result, although it is possible to draw an inference with a certain degree of accuracy for musical pieces that have a predefined bar-line/beat structure, it is difficult to appropriately draw an inference for musical pieces that have various types of bar-line/beat structures, such as musical pieces in which the time signatures change or that have a bar-line/beat structure different from the training data. This was presumed to be one major cause of the occurrence of the temporal error described above.

In contrast, in the present embodiment, the input token sequence used for the inference is configured to include a plurality of bar-line/beat tokens indicating the bar-line/beat positions of the musical piece, as described above. The inference model 5 can thus specify the bar-line/beat structure of the musical piece and then carry out the inference process with respect to the musical piece. As a result, in the model generation device 1, it is possible to generate the trained inference model 5 in which temporal errors caused by the bar-line/beat structure are less likely to occur. The musical piece inference device 2 uses such a trained inference model 5 to execute the inference task with respect to the target data 221 including the plurality of bar-line/beat tokens. As a result, it is possible to reduce the probability that a temporal error will occur in the inference task with respect to the musical piece.

In an example, the model generation device 1 can generate the trained inference model 5 that has acquired the ability to carry out inference processes, such as generating a sequence of notes of an arranged musical piece from the sequence of notes of the musical piece from which an inference is to be drawn, estimating local attributes of the musical piece from the sequence of notes of the musical piece from which an inference is to be drawn, generating a musical score from the sequence of notes of the musical piece from which an inference is to be drawn, generating a sequence of notes of an arranged musical piece from the sequence of elements of the musical piece from which an inference is to be drawn, etc., and the trained inference model 5 in which temporal errors caused by the bar-line/beat structure are less likely to occur. In a scenario in which these inference processes are executed, the musical piece inference device 2 can reduce the probability that a temporal error will occur.

In the example of FIG. 1, the model generation device 1 and the musical piece inference device 2 are connected to each other via a network. The type of network can be suitably selected from the Internet, a wireless communication network, a mobile communication network, a telephone network, a dedicated network, etc. However, the method of exchanging data between the model generation device 1 and the musical piece inference device 2 is not limited to this example and can be suitably selected in accordance with the implementation. For example, data can be exchanged between the model generation device 1 and the musical piece inference device 2 through the use of a storage medium.

Further, in the example of FIG. 1, the model generation device 1 and the musical piece inference device 2 are separate computers. However, the configuration of the inference system 100 according to the present embodiment is not limited to such an example and can be appropriately determined in accordance with the implementation. For example, the model generation device 1 and the musical piece inference device 2 can be a single computer. Further, for example, at least one of the model generation device 1 or the musical piece inference device 2, or both can be constituted by a plurality of computers. When a plurality of computers are used, the distribution of information processing can be appropriately determined in accordance with the implementation.

### § 2 Configuration Examples

Hardware Configuration

<Model Generation Device>

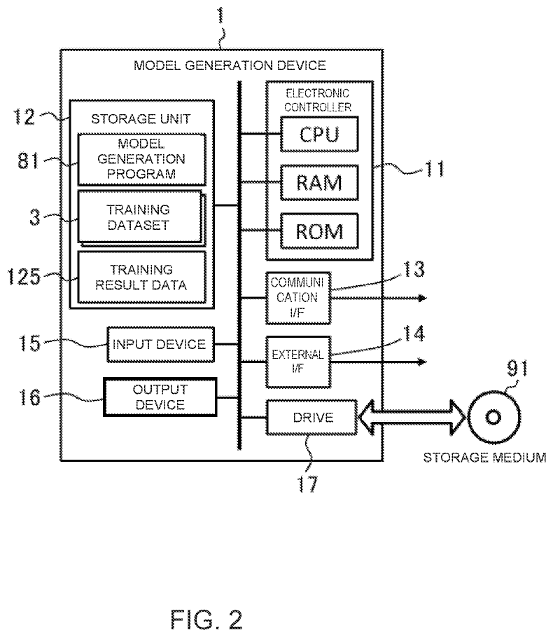

FIG. 2 schematically illustrates an example of the hardware configuration of the model generation device 1 according to the present embodiment. As shown in FIG. 2, the model generation device 1 according to the present embodiment is a computer in which an electronic controller (control unit) 11, a storage unit 12, a communication interface 13, an external interface 14, an input device 15, an output device 16, and a drive 17 are electrically connected. In FIG. 2, the communication interface and the external interface are described as “communication I/F” and “external I/F.”

The electronic controller 11 includes one or processors such as CPUs (Central Processing Unit), a RAM (Random Access Memory), a ROM (Read Only Memory), etc., which are examples of hardware processor resources, and is configured to execute information processing based on a program and various data. The term “electronic controller” as used herein refers to hardware that executes software programs. The storage unit 12 is an example of a memory (computer memory). The storage unit 12 can be any computer storage device or any computer readable medium with the sole exception of a transitory, propagating signal, and can include nonvolatile memory and volatile memory. Any known storage medium, such as a magnetic storage medium or a semiconductor storage medium, or a combination of a plurality of types of storage media can be freely employed as the storage unit 12. For example, the storage unit 12 is for example, a hard disk drive, a solid-state drive, etc. In the present embodiment, the storage unit 12 stores various information, such as a model generation program 81, a plurality of training datasets 3, training result data 125, etc.

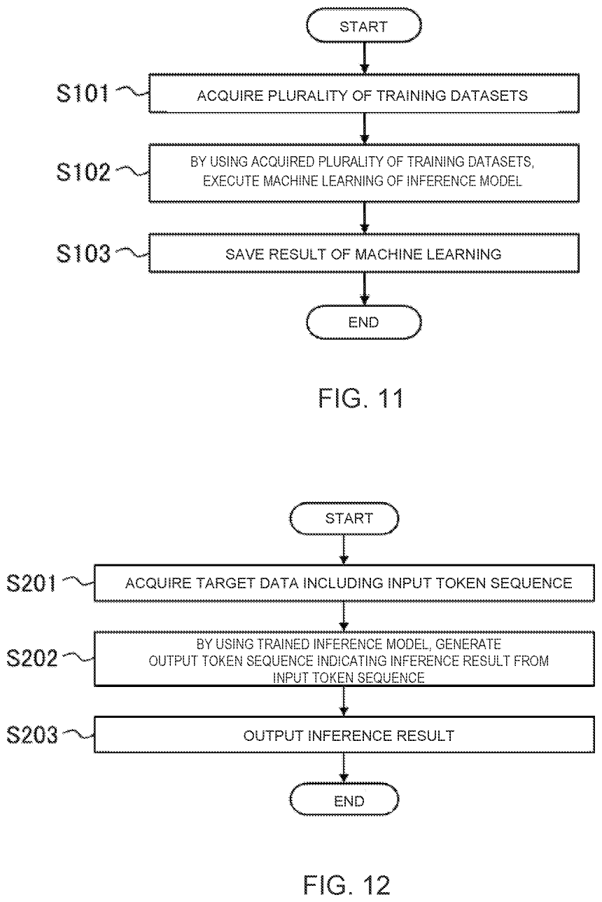

The model generation program 81 causes the model generation device 1 to execute machine learning information processing (FIG. 11), described further below, for generating the trained inference model 5. The model generation program 81 includes a series of instructions for the information processing. The plurality of training datasets 3 are used for generating the trained inference model 5. The training result data 125 indicate information related to the generated trained inference model 5. In the present embodiment, the training result data 125 are generated as a result of executing the model generation program 81. The details will be described further below.

The communication interface 13 is an interface for carrying out wired or wireless communication via a network, such as a wired LAN (Local Area Network) module, a wireless LAN module, etc. The model generation device 1 can use the communication interface 13 in order to execute data communication via a network with other information processing devices. The external interface 14 is an interface for connecting to an external device, such as a USB (Universal Serial Bus) port, a dedicated port, etc. The type and number of the external interfaces 14 can be arbitrarily selected.

The model generation device 1 can be connected to a device for obtaining each of the training datasets 3 via at least one of the communication interface 13, the external interface 14, or both. As an example, the input token sequence of the training data 31 can be generated from performance information obtained by an electronic instrument. In the case that generation of this input token sequence from the performance information is carried out in the model generation device 1, the model generation device 1 can be connected to the electronic instrument via the communication interface 13 and/or the external interface 14 and can collect the performance information for generating the training data 31 by the electronic instrument.

The input device 15 is a mouse, a keyboard, etc., for inputting data. Further, the output device 16 is a display, a speaker, etc., for outputting data. An operator, such as a user, can use the input device 15 and the output device 16 in order to operate the model generation device 1.

The drive 17 is a drive device such as a CD drive, DVD drive, etc., used to read various information such as programs stored on a storage medium 91. The storage medium 91 accumulates information, such as programs, by electronic, magnetic, optical, mechanical, or chemical actions, such that the computer and other devices and machines can read the various stored information such as programs. The model generation program 81 and/or the plurality of training datasets 3 can be stored on the storage medium 91. The model generation device 1 can acquire the model generation program 81 and/or the plurality of training datasets 3 from the storage medium 91. A disc-type storage medium, such as a CD or a DVD, is shown in FIG. 2 as an example of the storage medium 91. However, the storage medium 91 is not limited to disc-type storage media but can be of a different type. An example of a different type of storage medium besides the disc-type medium is semiconductor memory, such as flash memory. The type of the drive 17 can be arbitrarily selected in accordance with the type of the storage medium 91.

With respect to the specific hardware configuration of the model generation device 1, constituent elements can be omitted, replaced, or supplemented as deemed appropriate in accordance with the implementation. For example, the electronic controller 11 can include a plurality of hardware processors. The electronic controller 12 can include, instead of the CPU or in addition to the CPU, a microprocessor, an FPGA (field-programmable gate array), etc. The storage unit 12 can be constituted by RAM and ROM included in the electronic controller 11. At least one or more of the communication interface 13, the external interface 14, the input device 15, the output device 16, or the drive 17 can be omitted. The model generation device 1 can be constituted by a plurality of computers. Here, the hardware configuration of each computer can or cannot be the same. Moreover, the model generation device 1 can be, in addition to an information processing device designed exclusively for the service to be provided, a general-purpose server device, PC (Personal Computer), etc.

<Musical Piece Inference Device>

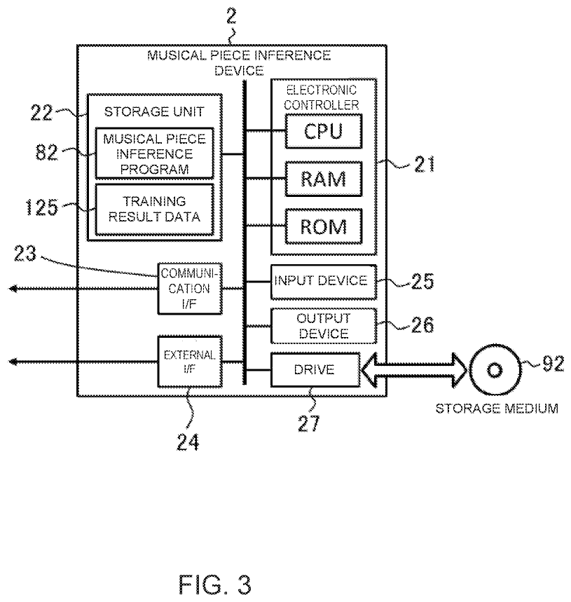

FIG. 3 schematically illustrates an example of the hardware configuration of the musical piece inference device 2 according to the present embodiment. As shown in FIG. 3, the musical piece inference device 2 according to the present embodiment is a computer in which an electronic controller (control unit) 21, a storage unit 22, a communication interface 23, an external interface 24, an input device 25, an output device 26, and a drive 27 are electrically connected.

The control device 21 to the drive 27 of the musical piece inference device 2 and the storage medium 92 can be respectively configured similarly to the electronic controller 11 to the drive 17 of the model generation device 1 and the storage medium 91. The electronic controller 21 includes one or more processor such as CPUs, a RAM, a ROM, etc., which are examples of hardware resources, and is configured to execute various information processing based on programs and various data. The term “electronic controller” as used herein refers to hardware that executes software programs. The storage unit 22 is one example of a memory (computer memory). The storage unit 22 can be any computer storage device or any computer readable medium with the sole exception of a transitory, propagating signal, and can include nonvolatile memory and volatile memory. Any known storage medium, such as a magnetic storage medium or a semiconductor storage medium, or a combination of a plurality of types of storage media can be freely employed as the storage unit 22. For example, the storage unit 22 is, for example, a hard disk drive, a solid-state drive, etc. In the present embodiment, the storage unit 22 stores various types of information, such as a musical piece inference program 82, the training result data 125, etc.

The musical piece inference program 82 is a program for causing the musical piece inference device 2 to execute information processing (FIG. 12), described further below, for using the trained inference model 5 to execute an inference task with respect to the musical piece. The musical piece inference program 82 includes a series of instructions for the information processing. The musical piece inference program 82 and/or the training result data 125 can be stored on the storage medium 92. Further, the musical piece inference device 2 can acquire the musical piece inference program 82 and/or the training result data 125 from the storage medium 92.

The musical piece inference device 2 can be connected to a device for obtaining the target data 221 via the communication interface 23 and/or the external interface 24. For example, an input token sequence of the target data 221 can be generated from performance information obtained by an electronic instrument. In the case that that the generation of this input token sequence from the performance information is performed in the musical piece inference device 2, the musical piece inference device 2 can be connected to the electronic instrument via the communication interface 23 and/or the external interface 24. The musical piece inference device 2 can also accept operations and inputs from an operator, such as a user, through the use of the input device 25 and the output device 26.

With respect to the specific hardware configuration of the musical piece inference device 2, constituent elements can be omitted, replaced, or supplemented as deemed appropriate in accordance with the implementation. For example, the electronic controller 21 can include a plurality of hardware processors. The electronic controller 21 can include, instead of the CPU or in addition to the CPU, a microprocessor, an FPGA, etc. The storage unit 22 can be constituted by RAM and ROM included in the electronic controller 21. At least one or more of the communication interface 23, the external interface 24, the input device 25, the output device 26, or the drive 27 can be omitted. The musical piece inference device 2 can be constituted by a plurality of computers. Here, the hardware configuration of each computer can or cannot be the same. Moreover, the musical piece inference device 2 can be, in addition to an information processing device designed exclusively for the service to be provided, a general-purpose server device, a general-purpose PC, etc.

### Software Configuration

### <Model Generation Device>

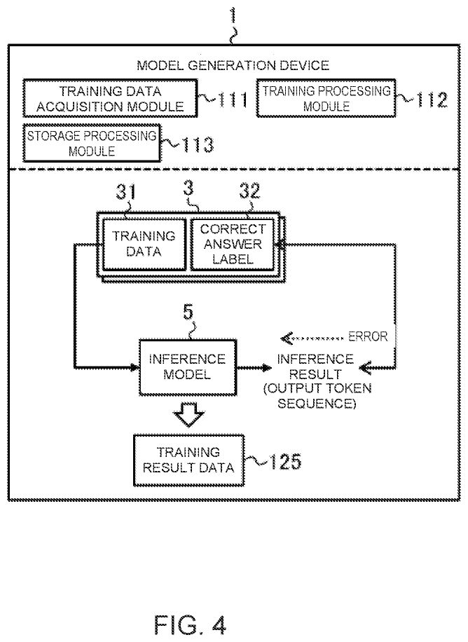

FIG. 4 schematically illustrates one example of the software configuration of the model generation device 1 according to the present embodiment. The electronic controller 11 of the model generation device 1 interprets instructions included in the model generation program 81 stored in the storage device 12 and executes control processes corresponding to the interpreted instructions. The model generation device 1 according to the present embodiment is thus configured to comprise a training data acquisition module 111, a training processing module 112, and a storage processing module 113, as software modules. That is, in the present embodiment, each software module of the model generation device 1 is realized and executed by the electronic controller 11 (CPU).

The training data acquisition module 111 is configured to acquire the plurality of training datasets 3. Each of the training datasets 3 includes a combination of the training data 31 and the correct answer label 32. The training data 31 include an input token sequence arranged to indicate at least a part of a musical piece for training. The input token sequence includes a plurality of bar-line/beat tokens arranged to indicate the bar-line/beat positions of the musical piece. Here, at least part of the musical piece can be defined as a prescribed length, such as four bars. The correct answer label 32 is configured to indicate the true value of an output token sequence corresponding to an inference result (a result of an inference) with respect to the musical piece.

The training processing module 112 is configured to, by using the acquired plurality of training datasets 3, execute the machine learning of the inference model 5. The machine learning is configured by training the inference model 5 such that, with respect to each of the training datasets 3, an output token sequence generated by the inference model 5 from the input token sequence included in the training data 31 matches the true value indicated by the correct answer label 32. Upon completion of this machine learning process, the trained inference model 5 is generated that has acquired the ability to execute the desired inference task.

The storage processing module 113 is configured to generate information related to the trained inference model 5 generated by the machine learning as the training result data 125 and to store the generated training result data 125 in a prescribed storage area. The training result data 125 can be appropriately configured to include information for reproducing the trained inference model 5.

### Example of Token

Any symbol, such as numbers, characters, graphics, etc., can be used for the tokens constituting the input token sequence and the output token sequence. The symbols (token representations) and data formats used for the tokens are not particularly limited as long as the symbols and data formats can be recognized by a computer and can be suitably selected in accordance with the implementation. The same applies to the bar-line/beat tokens. As examples of the tokenization method, two tokenization methods, action-based and note-based, will be illustrated below.

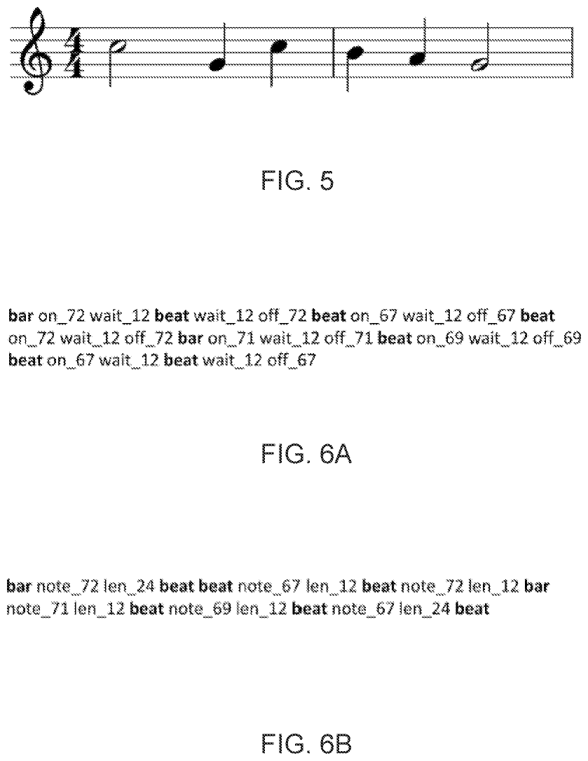

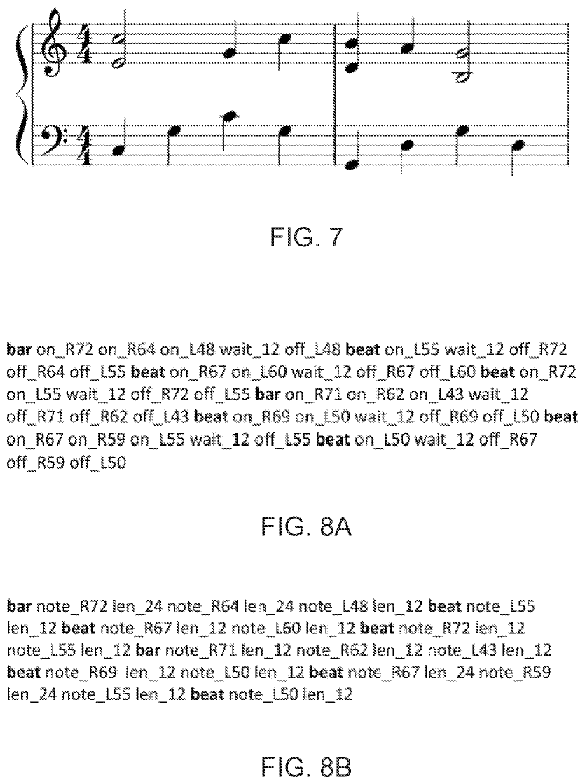

FIG. 5 is a musical score showing an example of at least a part of a musical piece. FIG. 6A shows an example of an input token sequence generated from the musical piece of FIG. 5 by an action-based tokenization method. FIG. 6B shows an example of an input token sequence generated from the musical piece of FIG. 5 by a note-based tokenization method. FIG. 7 is a musical score showing an example of an arranged musical piece (inference result) obtained from the musical piece of FIG. 5, as an example of an inference task. FIG. 8A shows an example of true values of an output token sequence obtained corresponding to the musical piece of FIG. 7 by the action-based tokenization method. FIG. 8B shows an example of true values of an output token sequence obtained corresponding to the musical piece of FIG. 7 by the note-based tokenization method.

The action-based tokenization method is a method of tokenization to show actions corresponding to notes or elements of the musical piece. Table 1 shows an example of token types and representations in the action-based tokenization method. On the other hand, the note-based tokenization method is a method of tokenization to show the notes of the musical piece as is. Table 2 shows an example of token types and representations in the note-based tokenization method. The following token types and representations are examples, and can be appropriately changed in accordance with the implementation.

TABLE 1

| Classification | Content | Example of token |
|---|---|---|
| Note on | Keyboard depression | on_72, on_67, on_R72, |
| (keystroke) | | on_L48, . . . |
| Note off | Keyboard release | off_72, off_67, off_R72, |
| (key release) | | off_L48, . . . |
| Delta time | Allow time to elapse | wait_12, . . . |
| (time difference) | (wait) | |

TABLE 2

| Classification | Content | Example of token |
|---|---|---|
| Note Pitch | Pitch of sound | note_72, note_67, note_R72, |
| (pitch) | | note_L48, . . . |
| Note value | Sound length | len_24, len_12, . . . |
| (phonetic value) | | |

Either one of the two methods described above can be employed as the tokenization method and token representation of the input token sequence and the output token sequence. As an example of a method of acquiring each of the training datasets 3, musical piece data indicating at least a part of the musical piece illustrated in FIG. 5 can be suitably acquired. The form of the musical piece data can be suitably selected in accordance with the implementation. As an example, the musical piece data can be acquired in formats such as encoded data (MIDI, etc.) or a musical score. The training data 31 of each of the training datasets 3 can be suitably generated so as to include the input token sequence shown in FIG. 6A or FIG. 6B from the obtained musical piece data. Further, in accordance with at least a part of the musical piece illustrated in FIG. 5, correct answer data indicating the true value of the inference result (result of arranging the musical piece in the example of FIG. 7) with respect to the musical piece, illustrated in FIG. 7, can be obtained. The correct answer label 32 of each of the training datasets 3 can be suitably generated so as to include the true values of the output token sequence shown in FIG. 8A or 8B from the obtained correct answer data. Any conversion process, such as natural language processing, can be employed for the generation of the input token sequence and the true values of the output token sequence. The input token sequence and the true values of the output token sequence can be generated manually by a person.

FIGS. 7, 8A, and 8B show examples of scenarios in which the inference task is to generate an arranged musical piece. However, the inference task to be performed by the inference model 5 is not limited in this way, as described above. Similarly, for other inference tasks, the true values of each inference result and the output token sequence can be obtained as required.

Of the tokens included in the input token sequence and the output token sequence illustrated in FIGS. 6A, 6B, 8A, and 8B, “bar” and “beat” are examples of bar-line/beat tokens. “bar” indicates a bar line, and “beat” number (the number of beats) indicates a time signature. As illustrated in FIGS. 6A and 6B, the input token sequence is configured to include a plurality of bar-line/beat tokens. The input token sequence is thus configured to be capable of specifying the bar-line/beat structure of the musical piece. Further, as illustrated in FIGS. 8A and 8B, the output token sequence can also be configured to include bar-line/beat tokens. These representations of bar-line/beat tokens are examples. The representations of the bar-line/beat tokens are not limited to these examples and can be appropriately determined in accordance with the implementation.

The same tokenization method and the same token representation can be used for the input token sequence and the output token sequence. In the above-described example, both the input token sequence and the output token sequence can employ an action-based or note-based tokenization method. However, the input token sequence and the output token sequence are not limited to such examples. It is not necessary for the input token sequence and the output token sequence to use the same tokenization method and the same token representation. The input token sequence and the output token sequence can employ different tokenization methods or different token representations.

As long as a computer can recognize at least a part of the musical piece from which an inference is to be drawn, the form of the tokens employed for the input token sequence is not particularly limited, and can be appropriately determined in accordance with the implementation. As long as a computer can recognize the inference result, the form of the tokens employed for the output token sequence is not particularly limited and can be appropriately determined in accordance with the implementation. Further, as long as a computer can recognize the bar-line/beat structure, the form of the bar-line/beat tokens is not particularly limited and can be appropriately determined in accordance with the implementation.

### An Example of an Inference Model

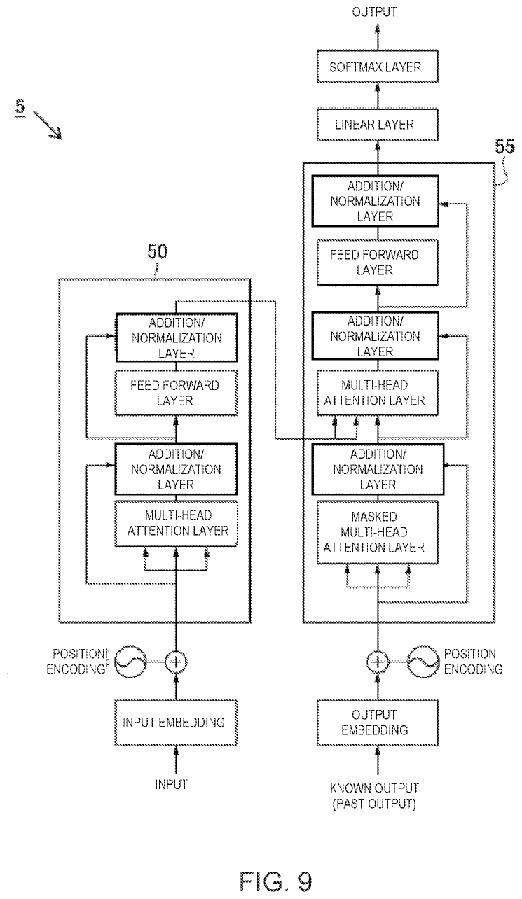

FIG. 9 schematically illustrates an example of the configuration of the inference model 5 according to the present embodiment. The inference model 5 is configured by a machine learning model that has machine learning-adjusted parameters. The type of machine learning model is not particularly limited and can be appropriately selected in accordance with the implementation. As long as the machine learning model is configured to accept an input token sequence and output an output token sequence indicating the inference result, the structure of the machine learning model is not particularly limited and can be appropriately determined in accordance with the implementation. As shown in FIG. 9, in an example, the inference model 5 can have a structure based on a Transformer as proposed in the reference document “Ashish Vaswani, Noam Shazeer, Niki Parmar, Jakob Uszkoreit, Llion Jones, Aidan N Gomez, Lukasz Kaiser, and Illia Polosukhin. Attention is all you need. In Advances in Neural Information Processing Systems, 2017.” A Transformer is a machine learning model that processes series data (natural language, etc.) and has an attention-based structure.

In the example of FIG. 9, the inference model 5 has an encoder 50 and a decoder 55. The encoder 50 has a structure constituted by a plurality of stacked blocks, each having a multi-head attention layer that seeks self-attention, and a feed-forward layer. The decoder 55, on the other hand, has a structure constituted by a stacked a plurality of blocks, each having a masked multi-head attention layer that seeks self-attention, a multi-head attention layer that seeks source/target attention, and a feed-forward layer. As shown in FIG. 9, each of the layers of the encoder 50 and the decoder 55 can have an addition and normalization layer. Each layer can include one or more nodes, and a threshold value can be set for each node. The threshold value can be expressed by an activation function. Further, a weight (connection load) can be set for the connections between nodes of adjacent layers. The threshold value and the weights of the connections between nodes are examples of the parameters of the inference model 5.

In one example of FIG. 9, the inference model 5 is configured to receive tokens included in the input token sequence in order from the beginning. The tokens input to the inference model 5 are each converted into vectors having a prescribed number of dimensions by an input embedding process and are provided with a value specifying the position within the musical piece (within the phrase) by a position encoding process, and are thereafter input to the encoder 50. The encoder 50 continually carries out processing by the multi-head attention layer and the feed-forward layer for the number of blocks in response to this input to acquire a feature representation and supplies the acquired feature expression to the decoder 55 (multi-head attention layer) of the next stage.

In addition to the input from the encoder 50, known (past) outputs from the decoder 55 (masked multi-head attention layer) are supplied to the decoder 55. That is, the inference model 5 illustrated in FIG. 9 is configured to have a recursive structure. In response to this input, the decoder 55 repeatedly executes processing by the masked multi-head attention layer, the multi-head attention layer, and the feed-forward layer for the number of blocks in order to acquire and output a feature representation. The output from the decoder 55 is transformed in a linear layer and a softmax layer to obtain tokens representing the inference result.

The training processing module 112 is configured to perform machine learning of the inference model 5 for each of the training datasets 3 using the input token sequence (plural tokens) included in the training data 31 as input data and the true values of the output token sequence indicated by the corresponding correct answer label 32 as teacher signals. Specifically, the training processing module 112 is configured to train the inference model 5 such that, for each of the training datasets 3, the output token sequence obtained by inputting the input token sequence included in the training data 31 to the inference model 5 and executing the arithmetic processing of the inference model 5 matches the true value indicated by the corresponding correct answer label 32. In other words, the training processing module 112 is configured to adjust the parameter values of the inference model 5 such that the error between the output token sequence generated from the input token sequence included in the training data 31 by the inference model 5, and the true values indicated by the corresponding correct answer label 32 is minimized for each of the training datasets 3. Any method, such as an error backpropagation method, can be used for the parameter adjustment. Further, a plurality of normalization methods (e.g., label smoothing, residual dropout, attention dropout) can be applied to the processing of the machine learning of the inference model 5.

### <Musical Piece Inference Device>

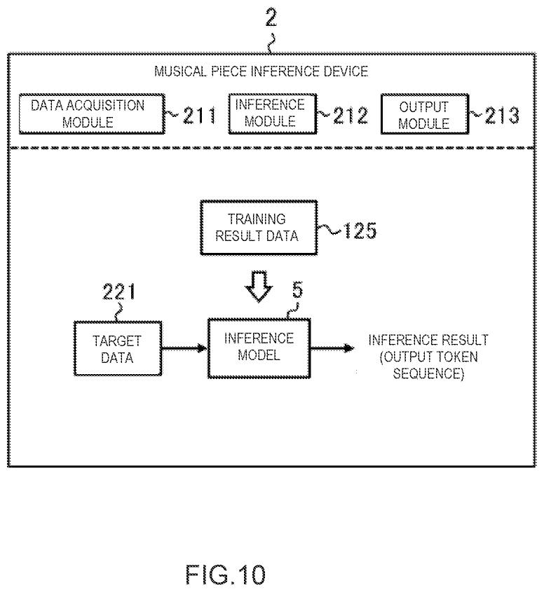

FIG. 10 schematically illustrates an example of the software configuration of the musical piece inference device 2 according to the present embodiment. The electronic controller 21 of the musical piece inference device 2 interprets instructions contained in the musical piece inference program 82 stored in the storage device 22 and executes control processes corresponding to the interpreted instructions. The musical piece inference device 2 according to the present embodiment is thus configured to comprise a data acquisition module 211, an inference module 212, and an output module 213, as software modules. That is, in the present embodiment, each software module of the musical piece inference device 2 is realized and executed by the electronic controller 21 (CPU), in the same manner as the model generation device 1.

The data acquisition module 211 acquires target data 221 including an input token sequence arranged to indicate at least a part of the musical piece. The input token sequence includes a plurality of bar-line/beat tokens arranged to indicate the bar-line/beat positions of the musical piece. The input token sequence included in the target data 221 can be generated in the same form as the input token sequence included in the training data 31 illustrated in FIGS. 6A and 6B.

The inference module 212 holds the training result data 125 and is thus provided with the trained inference model 5. The inference module 212, by using the trained inference model 5, generates an output token sequence indicating the result of inference with respect to the musical piece from the input token sequence included in the target data 221. In the example of FIG. 9, the inference module 212 sequentially inputs the input token sequence included in the target data 221 to the encoder 50 of the trained inference model 5 (specifically, to the multi-head attention layer located first after the input embedding layer) and executes the arithmetic processing of the encoder 50 and the decoder 55. As a result of this arithmetic processing, the inference module 212 sequentially acquires the tokens output from the trained inference model 5 (in the example of FIG. 9, the softmax layer located last) to generate the output token sequence constituting the inference result. At the time of this processing, the output token sequence can be generated using a search method such as beam search. More specifically, to generate the output token sequence, the inference module 212 can retain n candidate tokens in descending order of the score from the probability distribution of the values output from the inference model 5 and select the candidate tokens such that the total score of m consecutive tokens is highest, (where n, m are integers greater than or equal to 2). The output token sequence generated by the inference module 212 can be configured in the same format as the output token sequence of the correct answer label 32 illustrated in FIGS. 8A and 8B.

The output module 213 is configured to output the inference result obtained by the processing of the inference module 212. The form of the output of the inference result is not particularly limited and can be appropriately determined in accordance with the implementation. As an example, the output token sequence can be output as is. As another example, the output module 213 can convert the output token sequence into a suitable form. For example, in the case that the inference task is generating an arranged musical piece, the output token sequence can be converted to information indicating the musical piece in the form of a sequence of notes, a musical score, etc., of the arranged musical piece. Then, the output module 213 can output the information obtained by the conversion as the inference result.

### <Other>

Each of the software modules of the model generation device 1 and the musical piece inference device 2 according to the present embodiment will be described in detail in the operation example described further below. In the present embodiment, an example in which each software module of the model generation device 1 and the musical piece inference device 2 is realized by a general-purpose CPU is described. However, some or all of the software modules can be realized by one or more dedicated processors (e.g., application-specific integrated circuits (ASIC)). Each of the modules described above can also be realized as a hardware module. Further, with respect to the software configuration of the model generation device 1 and the musical piece inference device 2, the software modules can be omitted, replaced, or supplemented as deemed appropriate in accordance with the implementation.

### § 3 Operation Example

### <Model Generation Device>

FIG. 11 is a flowchart showing an example of a processing procedure of the model generation device 1 according to the present embodiment. The processing procedure of the model generation device 1 described below is an example of the model generation method. However, the processing procedure of the model generation device 1 described below is merely an example, and each step can be modified to the extent possible. The steps of the following processing procedure can be omitted, replaced, or supplemented as deemed appropriate in accordance with the implementation.

(Step S101)

In Step S101, the electronic controller 11 operates as the training data acquisition module 111 and acquires the plurality of training datasets 3.

The training datasets 3 can be generated as required. Musical piece data indicating a musical piece in another form, such as encoded data or a musical score, can be obtained, and the input token sequence constituting the training data 31 can be generated as required from the obtained musical piece data. The correct answer label 32 can be generated as required so as to indicate an output token sequence to be the true values of the inference result with respect to the musical piece.

The process for generating the training datasets 3 can be performed on any computer. In one example, the process for generating each of the training datasets 3 can be executed by the model generation device 1 (electronic controller 11). In another example, at least a part of the plurality of training datasets 3 can be generated by another computer. In this case, the model generation device 1 (electronic controller 11) can acquire the training datasets 3 generated by the other computer via a network, the storage medium 91, or the like. The sufficient number of training datasets 3 to ensure machine learning to be acquired can be suitably determined. When the plurality of training datasets 3 are acquired, the electronic controller 11 advances the process to the next Step S102.

(Step S102)

In Step S102, the electronic controller 11 operates as the training processing module 112 and executes the machine learning of the inference model 5 by using the acquired plurality of training datasets 3.

As an example of a specific process of machine learning, the electronic controller 11 sequentially inputs the input token sequence included in the training data 31 of each of the training datasets 3 to the inference model 5, repeatedly executes the arithmetic processing of the inference model 5, and sequentially generates the tokens constituting the output token sequence. By this arithmetic processing, the electronic controller 11 can obtain the output token sequence indicating the inference result corresponding to the training data 31 of each of the training datasets 3. The electronic controller 11 then calculates the error between the obtained output token sequence and the true value indicated by the corresponding correct answer label 32, and also calculates the gradient of the calculated error. The electronic controller 11 uses the error backpropagation method to backpropagate the gradient of the calculated error to calculate the error of the parameter value of the inference model 5. The electronic controller 11 adjusts the parameter value of the inference model 5 based on the calculated error. The electronic controller 11 can repeat the adjustment of the parameter values of the generative model 5 by the series of processes described above until a prescribed condition is met (e.g., until the process is performed a specified number of time, or the sum of the calculated errors is less than or equal to a threshold value).

By this machine learning, the inference model 5 is trained such that, with respect to each of the training datasets 3, an output token sequence generated from the input token sequence included in the training data 31 matches the true value indicated by the corresponding correct answer label 32. As a result of the machine learning, it is possible to generate the trained inference model 5 that has acquired the ability to execute the inference task so as to match the true value provided by the correct answer label 32. When the machine learning process is completed, the electronic controller 11 advances the process to the subsequent Step S103.

(Step S103)

In Step S103, the electronic controller 11 operates as the storage processing module 113 and generates information related to the trained inference model 5 generated by machine learning as the training result data 125. The training result data 125 holds information for reproducing the trained inference model 5. As one example, the training result data 125 can include information that indicates the value of each parameter of the inference model 5 obtained by the adjustment of the machine learning described above. In some cases, the training result data 125 can include information that indicates the structure of the inference model 5. For example, the structure can be specified by the number of layers, the type of layer, the number of nodes n each layer, the connection relationship between nodes of adjacent layers, etc. The electronic controller 11 stores the generated training result data 125 in a prescribed storage area.

The prescribed storage area can be the RAM in the electronic controller 11, the storage unit 12, the external storage device, a storage medium, or a combination thereof. The storage medium can be a CD, DVD, etc., and the electronic controller 11 can store the training result data 125 in the storage medium via the drive 17. The external storage device can be a data server, such as NAS. In this case, the electronic controller 11 can use the communication interface 13 to store the training result data 125 in the data server via a network. Further, the external storage device can be an external storage device connected to the model generation device 1, for example.

Once the training result data 125 are stored, the electronic controller 11 ends the processing procedure of the model generation device 1 according to the present operation example.

The generated training result data 125 can be provided to the musical piece inference device 2 at any timing. For example, the electronic controller 11 can transfer the training result data 125 to the musical piece inference device 2 as a process of Step S103 or separately from the process of Step S103. The musical piece inference device 2 can receive this transfer to acquire the training result data 125. Further, for example, the musical piece inference device 2 can use the communication interface 23 and access the model generation device 1 or a data server via a network, to acquire the training result data 125. Further, for example, the musical piece inference device 2 can acquire the training result data 125 via the storage medium 92. Further, for example, the training result data 125 can be incorporated in the musical piece inference device 2 in advance.

Further, the electronic controller 11 can repeat the processes of Steps S101-S103 periodically or at irregular intervals to update or generate new training result data 125. At the time of this repetition, at least part of the plurality of training datasets 3 used for the machine learning can be changed, modified, supplemented, deleted, etc., as deemed appropriate. The electronic controller 11 can thereby update or regenerate the trained inference model 5. The electronic controller 11 can then provide the updated or newly generated training result data 125 to the musical piece inference device 2 by any means to update the training result data 125 held by the musical piece inference device 2.

### <Musical Piece Inference Device>

FIG. 12 is a flowchart showing an example of a processing procedure of the musical piece inference device 2 according to the present embodiment. The processing procedure of the musical piece inference device 2 described below is an example of the musical piece inference method. However, the processing procedure of the musical piece inference device 2 described below is merely an example, and each step thereof can be modified as much as possible. With respect to the following processing procedure, the steps can be omitted, replaced, or supplemented as deemed appropriate in accordance with the embodiment.

(Step S201)

In Step S201, the electronic controller 21 operates as the data acquisition module 211 and acquires the target data 221 including the input token sequence arranged to indicate at least a part of the musical piece.

The input token sequence included in the target data 221 can be generated by any method. In one example, the input token sequence can be generated from data of another form, such as encoded data or a musical score. In another example, the input token sequence can be directly generated by any method (for example, manual input).

Further, the target data 221 can be acquired via any path. As an example, the input token sequence can be generated by the musical piece inference device 2. In this case, the electronic controller 21 can acquire the target data 221 as a result of executing said generation process. In another example, the generation of the input token sequence can be performed by a computer other than the musical piece inference device 2. In this case, the electronic controller 21 can acquire the target data 221 via a network, the storage medium 92, or the like. Once the target data 221 are acquired, the electronic controller 21 advances the process to the next Step S202.

(Step S202)

In Step S202, the electronic controller 21 operates as the inference module 212 and refers to the training result data 125 to set up the trained inference model 5 by machine learning. The electronic controller 21, by using the trained inference model 5, generates, from the input token sequence included in the target data 221, an output token sequence indicating the result of drawing an inference with respect to the musical piece. Specifically, the electronic controller 21 inputs the input token sequence included in the target data 221 to the trained inference model 5 and executes the arithmetic processing of the trained inference model 5. In the example of FIG. 9 above, the electronic controller 21 sequentially inputs the tokens included in the input token sequence to the trained inference model 5 in order from the beginning, and repeatedly executes the feedforward arithmetic processing of the trained inference model 5 to sequentially generate the tokens that constitute the output token sequence. As a result of this arithmetic processing, the electronic controller 21 acquires, from the trained inference model 5, the output token sequence indicating the result of executing the inference task with respect to at least a part of the musical piece indicated by the target data 221. When execution of the inference task (arithmetic processing of the trained inference model 5) is completed, the electronic controller 21 advances the process to the next Step S203.

(Step S203)

In Step S203, the electronic controller 21 operates as the output module 213 and outputs the inference result obtained by the process of Step S202. The output destination and the output format are not particularly limited and can be appropriately determined in accordance with the implementation. In one example, the output destination can be the RAM, the storage unit 22, a storage medium, an external storage device, another computer, another device, or the like. As an example, the electronic controller 21 can output the output token sequence as is. In another example, the electronic controller 21 can convert the output token sequence into a suitable format and output the information obtained by the conversion. As a specific example, in the case that the inference task is generating an arranged musical piece, the electronic controller 21 can generate, from the output token sequence, information in the format of a sequence of notes, a musical score, etc., of the arranged musical piece and output the generated information. In the case of obtaining the inference result in the form of a musical score, the electronic controller 21 can output an instruction to a printing device (not shown) to print the musical score on a paper medium.

When the output of the inference result is completed, the electronic controller 21 ends the processing procedure of the musical piece inference device 2 according to the present operation example. The electronic controller 21 can repeatedly execute the processes of Steps S201-S203 periodically or at irregular intervals, in accordance with an operator's request. At the time of this repetition, at least part of the target data 221 (input token sequence) obtained in Step S201 can be changed, modified, supplemented, deleted, etc., as deemed appropriate. In this way, the electronic controller 21 can use the trained inference model 5 to generate the inference result with respect to the new musical piece.

### <Characteristics>

As described above, in the present embodiment, the input token sequence, which is the training data 31 of each of the training datasets 3 used for the machine learning of Step S102, is configured to include a plurality of bar-line/beat tokens indicating the bar-line/beat positions of the musical piece. As a result, the inference model 5 is trained to be able to execute the inference process with respect to the musical piece based on the understanding of the bar-line/beat structure of the musical piece using the bar-line/beat tokens. Thus, the machine learning process of Step S102 can generate a trained inference model 5 in which temporal errors caused by the bar-line/beat structure are less likely to occur.

Further, in Step S201 described above, the input token sequence including a plurality of bar-line/beat tokens is acquired as the target data 221. Then, in Step S202, the input token sequence including the plurality of bar-line/beat tokens is used for drawing inferences with respect to a musical piece by the trained inference model 5. The inference model 5 can thereby ascertain the bar-line/beat structure of the musical piece from which an inference is to be drawn and then carry out the inference process with respect to the musical piece. As a result, it is possible to reduce the probability that a temporal error will occur in the inference task with respect to the musical piece of Step S202.

Further, in the present embodiment, the bar-line/beat tokens can be arranged to indicate the respective positions of bar lines and beats in the input token sequence. That is, the plurality of bar-line/beat tokens can be arranged such that both the bar lines and the beats can be ascertained. The inference model 5 can thus completely identify the bar-line/beat structure of the musical piece indicated by the input token sequence based on the bar-line/beat tokens. It is thus possible to generate the trained inference model 5 in which temporal errors are less likely to occur in the process of Step S102 described above. It is possible to also reduce the probability that a temporal error will occur in the inference task with respect to the musical piece of Step S202.

In the present embodiment, the output token sequence can also be configured to include bar-line/beat tokens. It is thus possible to easily identify the location where the temporal error occurred based on the positions of the bar-line/beat tokens included in the output token sequence, even if a temporal error occurs in the inference process of above-described Step S202. As a result, it is possible to easily correct the obtained inference result.

### § 4 Modified Example

An embodiment of this disclosure has been described above in detail, but the above-mentioned description is merely an example of this disclosure in all respects. Various refinements and modifications can of course be made without deviating from the scope of this disclosure.

For example, in the present embodiment a machine learning model (FIG. 9) having the recursive structure of a Transformer is presented as an example of the generative model 5. However, the recursive structure is not limited to the example shown in FIG. 9. A recursive structure indicates a structure that is configured to enable processing with respect to the target (current) input by referring to inputs prior to the target. As long as such computations are possible, the recursive structure need not be limited and can be suitably determined in accordance with the implementation. In another example, the recursive structure can be configured in accordance with a known structure, such as an RNN (Recurrent Neural Network), LSTM (Long short-term memory), etc.

Further, in the embodiment described above, the inference model 5 is configured to have a recursive structure. However, the configuration of the inference model 5 is not limited to this example. The recursive structure can be omitted. The inference model 5 can be configured in accordance with a neural network having a known structure such as a fully connected neural network or a convolutional neural network. Further, the mode of inputting the input token sequence to the inference model 5 is not limited to the example of the embodiment described above. In another example, the inference model 5 can be configured to receive a plurality of tokens contained in the input token sequence at one time.

Further, in the embodiment described above, as long as the output token sequence indicating the inference result can be generated from the input token sequence corresponding to the musical piece, the type of machine learning model that constitutes the inference model 5 need not be limited and can be suitably selected in accordance with the implementation. Moreover, in the embodiment described above, in the case that the inference model 5 consists of a machine learning model having a plurality of layers, the type of each layer can be suitably selected in accordance with the implementation. A convolution layer, a pooling layer, a dropout layer, a normalized layer, a fully connected layer, etc., can be used for each layer. The constituent elements of the structure of the inference model 5 can be omitted, replaced, or supplemented as appropriate.

In the embodiment described above, the inference model 5 can be configured to also accept information inputs other than the input token sequence. Further, the inference model 5 can also be configured to output other information besides the output token sequence.

### § 5 Examples

In order to verify the validity of this disclosure, trained inference models according to the following example and comparative example were generated, and the inference accuracy of the generated trained inference models was evaluated.

Specifically, 261,396 samples of original musical pieces were prepared, and the action-based tokenization method shown in Table 1, FIG. 6A, and FIG. 8A was employed to generate an input token sequence constituting training data from the musical pieces of each prepared sample. Further, assuming the arrangement of a musical piece as the inference task, arranged musical pieces of 261,396 samples, each corresponding to the original musical pieces were prepared. Then, in the same manner as the input token sequence, an action-based tokenization method was employed to generate the true values of the output token sequence constituting the correct answer label from each sample of the arranged musical pieces. The generated input token sequence (training data) and the true values of the output token sequence (correct answer label) were associated with each other to generate a training dataset of 261,396 samples. As shown in FIGS. 6A and 8A, in the example, the training dataset was obtained by placing bar-line/beat tokens at the positions of the bar lines and the beats for each of the input token sequence and the true value of the output token sequence. In the comparative example, on the other hand, the training dataset was obtained without placing bar-line/beat tokens in either the input token sequence or the true value of the output token sequence (the other conditions were the same as those in the example).

The Transformer illustrated in FIG. 9 was employed as the structure of the inference model according to the example and the comparative example. By the same method as the embodiment described above, the training dataset of the prepared 261,396 samples was used to execute machine learning to generate the trained inference models according to the example and the comparative example.

Separately from the training data, a musical piece of 1,000 samples (each sample has a time length of 4 bars) was prepared to obtain an input token sequence (target data) of 1,000 samples from the prepared musical piece. In the same manner as the training dataset, each bar-line/beat token was placed at the positions of the bar lines and the beats in the input token sequence according to the example. On the other hand, bar-line/beat tokens were not placed in the input token sequence according to the comparative example (other conditions were the same as in the example).

Next, the respective trained inference models of the example and the comparative example were used to execute the inference task with respect to the target data of each sample, to obtain the output token sequence indicating the inference result. Then, with respect to the original musical piece (that is, the musical piece indicated by the target data), it was evaluated whether there was deviation in the number of beats in the arrangement, indicated by the output token sequence. As a result, in the comparative example, deviations in the number of beats occurred with a probability of 17.4%. On the other hand, in the example, deviations in the number of beats occurred with a probability of 4.1%. From this result, it was found that the probability of occurrence of temporal errors can be greatly reduced by entering bar-line/beat tokens indicating the bar-line/beat structure.

### § 6 Additional Statement

That is, a musical piece inference device according to one aspect of this disclosure comprises a data acquisition module for acquiring target data including an input token sequence arranged to indicate at least a part of a musical piece, wherein the input token sequence includes a plurality of bar-line/beat tokens arranged to indicate the bar-line/beat positions of the musical piece; an inference module for using a trained inference model to generate an output token sequence indicating a result of an inference with respect to the musical piece from the input token sequence included in the target data; and an output module for outputting the inference result. The output token sequence can also be configured to include bar-line/beat tokens.

In the musical piece inference device according to one aspect described above, each of the plurality of bar-line/beat tokens can be arranged at each bar line and beat position of the musical piece in the input token sequence.

In the musical piece inference device according to one aspect described above, the input token sequence can be generated corresponding to a sequence of notes of at least a part of the musical piece, and the output token sequence can be generated so as to indicate a sequence of notes of at least a part of an arranged musical piece, as a result of drawing inferences with respect to the musical piece.

In the musical piece inference device according to one aspect described above, the input token sequence can be generated corresponding to a sequence of notes of at least a part of the musical piece, and the output token sequence can be generated so as to indicate a result of estimating local attributes of at least a part of the musical piece, as a result of drawing inferences with respect to the musical piece.

In the musical piece inference device according to one aspect described above, the input token sequence can be generated corresponding to a sequence of notes of at least a part of the musical piece, and the output token sequence can be generated so as to indicate a musical score of at least a part of the musical piece, as a result of drawing inferences with respect to the musical piece.

In the musical piece inference device according to one aspect described above, the input token sequence can be generated corresponding to a sequence of notes of at least a part of the musical piece, and the output token sequence can be generated so as to indicate a sequence of notes of at least a part of the arranged musical piece, as a result of drawing inferences with respect to the musical piece.

Embodiments of this disclosure are not limited to a musical piece inference device configured to use a trained inference model. One aspect of this disclosure can be a model generation device that is configured to generate a trained inference model used in any of the embodiments described above.

For example, a model generation device according to one aspect of this disclosure comprises a training data acquisition module for acquiring a plurality of training datasets, each composed of a combination of training data and correct answer data, wherein the training data include an input token sequence arranged to indicate at least a part of a musical piece for training, the input token sequence includes a plurality of bar-line/beat tokens arranged to indicate the bar-line/beat positions of the musical piece, and the correct answer label is configured to indicate the true value of an output token sequence corresponding to an inference result with respect to the musical piece; and, a training processing module for using the acquired plurality of training datasets to execute machine learning of an inference model; wherein the machine learning comprises training the inference model such that, with respect to each of the training datasets, an output token sequence generated by the inference model from the input token sequence included in the training data matches the true value indicated by the correct answer label.

In the model generation device according to one aspect described above, each of the plurality of bar-line/beat tokens can be arranged at each bar line and beat position of the musical piece in the input token sequence.

In the model generation device according to one aspect described above, the input token sequence included in the training data of each of the training datasets can be generated corresponding to a sequence of notes of at least a part of the musical piece, and the output token sequence of the correct answer label of each of the training datasets can be configured so as to indicate the true values of a sequence of notes of at least a part of an arranged musical piece, as the true values of the inference result with respect to the musical piece.

In the model generation device according to one aspect described above, the input token sequence included in the training data of each of the training datasets can be generated corresponding to a sequence of notes of at least a part of the musical piece, and the output token sequence of the correct answer label of each of the training datasets can be configured so as to indicate true values of the result of inferring local attributes in at least a part of the musical piece, as the true values of the inference result with respect to the musical piece.

In the model generation device according to one aspect described above, the input token sequence included in the training data of each of the training datasets can be generated corresponding to a sequence of notes of at least a part of the musical piece, and the output token sequence of the correct answer label of each of the training datasets can be configured so as to indicate the true values of a musical score of at least a part of the musical piece, as the true values of the inference result with respect to the musical piece.

In the model generation device according to one aspect described above, the input token sequence included in the training data of each of the training datasets can be generated corresponding to a sequence of notes of at least a part of the musical piece, and the output token sequence of the correct answer label of each of the training datasets can be configured so as to indicate the true values of a sequence of notes of at least a part of the arranged musical piece, as the true values of the inference result with respect to the musical piece.

As another embodiment of the musical piece inference device and the model generation device according to the above-described embodiments, one aspect of this disclosure can be an information processing method that realizes some or all of the configurations described above; an information processing system; a program, or a storage medium that can be read by a computer, or other devices, machines, etc., storing such a program. Here, a computer-readable storage medium accumulates information, such as programs, by electric, magnetic, optical, mechanical, or chemical actions.

For example, a musical piece inference method according to one aspect of this disclosure is an information processing method in which a computer executes a step for acquiring target data including an input token sequence arranged to indicate at least a part of a musical piece, wherein the input token sequence includes a plurality of bar-line/beat tokens arranged to indicate the bar-line/beat positions of the musical piece; a step for using a trained inference model to generate an output token sequence indicating a result of an inference with respect to the musical piece from the input token sequence included in the target data; and a step for outputting the inference result.

Further, for example, a musical piece inference program according to one aspect of this disclosure is a program for causing a computer to execute a step for acquiring target data including an input token sequence arranged to indicate at least a part of a musical piece, wherein the input token sequence includes a plurality of bar-line/beat tokens arranged to indicate bar-line/beat positions of the musical piece; a step for using a trained inference model to generate an output token sequence indicating a result of an inference with respect to the musical piece from the input token sequence included in the target data; and a step for outputting the inference result.

Further, for example, a model generation method according to one aspect of this disclosure is an information processing method in which a computer executes a step for acquiring a plurality of training datasets, each composed of a combination of training data and correct answer data, wherein the training data include an input token sequence arranged to indicate at least a part of a musical piece for training, the input token sequence includes a plurality of bar-line/beat tokens arranged to indicate bar-line/beat positions of the musical piece, and the correct answer label is configured to indicate a true value of an output token sequence corresponding to an inference result with respect to the musical piece; and a step for using the acquired plurality of training datasets to execute machine learning of an inference model, wherein the machine learning comprises training the inference model such that, with respect to each of the training datasets, an output token sequence generated by the inference model from the input token sequence included in the training data matches the true value indicated by the correct answer label.

Further, a model generation program according to one aspect of this disclosure is a program for causing a computer to execute a step for acquiring a plurality of training datasets, each composed of a combination of training data and correct answer data, wherein the training data include an input token sequence arranged to indicate at least a part of a musical piece for training, the input token sequence includes a plurality of bar-line/beat tokens arranged to indicate bar-line/beat positions of the musical piece, and the correct answer label is configured to indicate the true values of an output token sequence corresponding to an inference result with respect to the musical piece; and a step for using the acquired plurality of training datasets to execute machine learning of an inference model, wherein the machine learning is configured by training the inference model such that, with respect to each of the training datasets, an output token sequence generated by the inference model from the input token sequence included in the training data matches the true value indicated by the correct answer label.

This disclosure provides a technology for reducing the probability of temporal errors in drawing inferences with respect to a musical piece.

What is claimed is:

1. A musical piece inference device comprising:
an electronic controller including at least one processor,
the electronic controller being configured to execute a plurality of modules including
a data acquisition module configured to acquire target data including an input token sequence arranged to indicate at least a part of a musical piece, the input token sequence including a plurality of bar-line/beat tokens arranged to indicate bar-line/beat positions of at least the part of the musical piece, the bar-line/beat positions being positions of bar lines of at least the part of the musical piece, positions of beats of at least the part of the musical piece, or both,
an inference module configured to, by using a trained inference model, generate an output token sequence indicating a result of an inference with respect to the musical piece from the input token sequence included in the target data, and
an output module configured to output the result of the inference.

2. The musical piece inference device according to claim 1, wherein
each of the plurality of bar-line/beat tokens is arranged at each of the positions of the bar lines and each of the positions of the beats in the input token sequence.

3. The musical piece inference device according to claim 1, wherein
the input token sequence is configured so as to correspond to a sequence of notes of at least the part of the musical piece, and
the inference module is configured to generate the output token sequence such that the output token sequence indicates a sequence of notes of at least a part of an arranged musical piece, as the result of the inference with respect to the musical piece.

4. The musical piece inference device according to claim 1, wherein
the input token sequence is configured so as to correspond to a sequence of notes of at least the part of the musical piece, and
the inference module is configured to generate the output token sequence such that the output token sequence indicates a result of estimating local attributes of at least the part of the musical piece, as the result of the inference with respect to the musical piece.

5. The musical piece inference device according to claim 1, wherein
the input token sequence is configured so as to correspond to a sequence of notes of at least the part of the musical piece, and
the inference module is configured to generate the output token sequence such that the output token sequence indicates a musical score of at least the part of the musical piece, as the result of the inference with respect to the musical piece.

6. The musical piece inference device according to claim 1, wherein
the input token sequence is configured so as to correspond to a sequence of elements of at least the part of the musical piece, and
the inference module is configured to generate the output token sequence such that the output token sequence indicates a sequence of notes of at least a part of an arranged musical piece, as the result of the inference with respect to the musical piece.

7. A musical piece inference method executed by a computer, the method comprising:
acquiring target data including an input token sequence arranged to indicate at least a part of a musical piece, the input token sequence including a plurality of bar-line/beat tokens arranged to indicate bar-line/beat positions of at least the part of the musical piece, the bar-line/beat positions being positions of bar lines of at least the part of the musical piece, positions of beats of at least the part of the musical piece, or both;
generating an output token sequence by using a trained inference model, the output token sequence indicating a result of an inference with respect to the musical piece from the input token sequence included in the target data; and
outputting the result of the inference.

8. The musical piece inference method according to claim 7, wherein
each of the plurality of bar-line/beat tokens is arranged at each of the positions of the bar lines and each of the positions of the beats in the input token sequence.

9. The musical piece inference method according to claim 7, wherein
the input token sequence is configured so as to correspond to a sequence of notes of at least the part of the musical piece, and
the output token sequence is generated so as to indicate a sequence of notes of at least a part of an arranged musical piece, as the result of the inference with respect to the musical piece.

10. The musical piece inference method according to claim 7, wherein
the input token sequence is configured so as to correspond to a sequence of notes of at least the part of the musical piece, and
the output token sequence is generated so as to indicate a result of estimating local attributes of at least the part of the musical piece, as the result of the inference with respect to the musical piece.

11. The musical piece inference method according to claim 7, wherein
the input token sequence is configured so as to correspond to a sequence of notes of at least the part of the musical piece, and
the output token sequence is generated so as to indicate a musical score of at least the part of the musical piece, as the result of the inference with respect to the musical piece.

12. The musical piece inference method according to claim 7, wherein
the input token sequence is configured so as to correspond to a sequence of elements of at least the part of the musical piece, and
the output token sequence is generated so as to indicate a sequence of notes of at least a part of an arranged musical piece, as the result of the inference with respect to the musical piece.

13. A model generation device comprising:
an electronic controller including at least one processor,
the electronic controller being configured to execute a plurality of modules including
a training data acquisition module configured to acquire a plurality of training datasets each of which includes a combination of training data and a correct answer label, the training data including an input token sequence arranged to indicate at least a part of a musical piece for training, the input token sequence including a plurality of bar-line/beat tokens arranged to indicate bar-line/beat positions of at least the part of the musical piece, the bar-line/beat positions being positions of bar lines of at least the part of the musical piece, positions of beats of at least the part of the musical piece, or both, the correct answer label being configured to indicate a true value of an output token sequence corresponding to a result of an inference with respect to the musical piece, and
a training processing module configured to execute machine learning of an inference model by using the plurality of training datasets, the machine learning being configured by training the inference model such that, with respect to each of the training datasets, an output token sequence generated by the inference model from the input token sequence included in the training data matches the true value indicated by the correct answer label.

14. The model generation device according to claim 13, wherein
each of the plurality of bar-line/beat tokens is arranged at each of the positions of the bar lines and each of the positions of the beats in the input token sequence.

15. The model generation device according to claim 13, wherein
the input token sequence included in the training data is configured so as to correspond to a sequence of notes of at least the part of the musical piece, and
the output token sequence of the correct answer label is configured so as to indicate a true value of a sequence of notes of at least a part of an arranged musical piece, as the true value of the result of the inference with respect to the musical piece.

16. The model generation device according to claim 13, wherein
the input token sequence included in the training data is configured so as to correspond to a sequence of notes of at least the part of the musical piece, and
the output token sequence of the correct answer label is configured to indicate a true value of a result of estimating local attributes of at least the part of the musical piece, as the true value of the result of the inference with respect to the musical piece.

17. The model generation device according to claim 13, wherein
the input token sequence included in the training data is configured so as to correspond to a sequence of notes of at least the part of the musical piece, and
the output token sequence of the correct answer label is configured so as to indicate a true value of a musical score of at least the part of the musical piece, as the true value of the result of the inference with respect to the musical piece.

18. The model generation device according to claim 13, wherein
the input token sequence included in the training data is configured so as to correspond to a sequence of elements of at least the part of the musical piece, and
the output token sequence of the correct answer label is configured so as to indicate a true value of a sequence of notes of at least a part of an arranged musical piece, as the true value of the result of the inference with respect to the musical piece.
